(19) United States
(12) Patent Application Publication
(10) Pub. No.: US 2020/0231254 A1
(43) Pub. Date: Jul. 23, 2020

(54) OFFSHORE FLOATING FACILITY

(71) Applicant: KABUSHIKI KAISHA KOBE SEIKO SHO (KOBE STEEL, LTD.), Hyogo (JP)

(72) Inventor: Shinji EGASHIRA, Takasago-shi, Hyogo (JP)

(73) Assignee: KABUSHIKI KAISHA KOBE SEIKO SHO (KOBE STEEL, LTD.), Hyogo (JP)

(21) Appl. No.: 16/487,810

(22) PCT Filed: Feb. 19, 2018
(86) PCT No.: PCT/JP2018/005674

§ 371 Date: Aug. 21, 2019

(30) Foreign Application Priority Data
Mar. 6, 2017 (JP) 2017-041835

(51) Int. Cl. B63B 25/16; B63H 21/38

(52) U.S. Cl. CPC B63B 25/16; F17C 9/02; B63H 21/38

(57) ABSTRACT

An offshore floating facility includes a hull and an intermediate fluid type vaporizer. The intermediate fluid type vaporizer includes: a pump which pumps sea water; an intermediate fluid evaporator which evaporates an intermediate fluid by the sea water pumped up by the pump; an LNG evaporator which vaporizes an LNG by the intermediate fluid evaporated in the intermediate fluid evaporator; a gas pipe which guides the intermediate fluid evaporated in the intermediate fluid evaporator to the LNG evaporator; and a liquid pipe which guides the intermediate fluid condensed in the LNG evaporator to the intermediate fluid evaporator. The LNG evaporator is disposed on a deck of the hull, the intermediate fluid evaporator is disposed below the deck, and the intermediate fluid is allowed to naturally circulate between the intermediate fluid evaporator and the LNG evaporator.

### TECHNICAL FIELD

The present invention relates to an offshore floating facility, and more particularly to an offshore floating facility which includes an intermediate fluid type vaporizer.

### BACKGROUND ART

Conventionally, there has been known a vaporizer for vaporizing a low-temperature liquefied gas such as a liquefied natural gas (LNG). As this type of vaporizer, for example, there has been known an intermediate fluid type vaporizer which uses an intermediate fluid (see Patent Literatures 1 and 2 as follows, for example). As shown in FIG. 16, for example, an intermediate fluid type vaporizer 80 disclosed in Patent Literature 2 as follows includes: an intermediate fluid evaporator 81 for evaporating an intermediate fluid stored in a shell 83 by sea water flowing through a heat transfer tube 84; and an LNG vaporizer 82 for vaporizing an LNG by an intermediate fluid in a gaseous form evaporated in the intermediate fluid evaporator 81. The intermediate fluid in a gaseous form is condensed in the LNG vaporizer 82 and is returned to the intermediate fluid evaporator 81. In this manner, the intermediate fluid type vaporizer 80 is configured such that heat of sea water which serves as a heat source medium is transferred to the LNG through the intermediate fluid. Such an intermediate fluid type vaporizer 80 may be disposed on a hull, thus forming a constituent element of an offshore floating facility such as a floating storage and regasification unit (FSRU).

The offshore floating facility is formed such that the intermediate fluid type vaporizer 80 is disposed on a deck of the hull. Accordingly, in the case where sea water is used as a heat source medium for evaporating the intermediate fluid, it is necessary to pump up sea water to the intermediate fluid evaporator 81 disposed on the deck. However, the deck of the hull is positioned at a high place from a sea level (for example, 10 m or more) and hence, a pump for pumping up sea water requires large power. Accordingly, an offshore floating facility where an intermediate fluid type vaporizer is used has a drawback that a running cost is pushed up when sea water is used as a heat source medium.

### CITATION LIST

### Patent Literature

Patent Literature 1: JP 2000-227200 A
Patent Literature 2: JP 2014-219047 A

### SUMMARY OF INVENTION

It is an object of the present invention to reduce a running cost in an offshore floating facility where an intermediate fluid type vaporizer is used.

According to an aspect of the present invention, there is provided an offshore floating facility which includes a hull having a deck, and an intermediate fluid type vaporizer disposed on the hull, wherein the intermediate fluid type vaporizer has: a pump for pumping sea water; an intermediate fluid evaporating part for evaporating an intermediate fluid by the sea water pumped by the pump; a liquefied gas vaporizing part for vaporizing a liquefied gas by the intermediate fluid in a gaseous form evaporated in the intermediate fluid evaporating part; a gas pipe for guiding the intermediate fluid in a gaseous form evaporated in the intermediate fluid evaporating part to the liquefied gas vaporizing part; and a liquid pipe for guiding the intermediate fluid condensed in the liquefied gas vaporizing part to the intermediate fluid evaporating part, the liquefied gas vaporizing part is disposed on the deck of the hull, the intermediate fluid evaporating part is disposed below the deck, and the intermediate fluid is allowed to naturally circulate between the intermediate fluid evaporating part and the liquefied gas vaporizing part.

### BRIEF DESCRIPTION OF DRAWINGS

FIG. 1 is a view schematically showing an offshore floating facility according to an embodiment.

FIG. 2 is a view schematically showing a main part of an LNG evaporator included in the offshore floating facility.

FIG. 3 is a view showing a connection relationship between a first liquid pipe and a shell of an intermediate fluid evaporator included in the offshore floating facility.

FIG. 4 is a view showing a connection relationship between a first liquid pipe and a shell of an intermediate fluid evaporator in a modification of the offshore floating facility.

FIG. 5 is a view showing a connection relationship between a first liquid pipe and a shell of an intermediate fluid evaporator in another modification of the offshore floating facility.

FIG. 6 is a view showing a connection relationship between a second liquid pipe and a shell of a second evaporator included in the offshore floating facility.

FIG. 7 is a view showing a connection relationship between a second liquid pipe and a shell of a second evaporator in a modification of the offshore floating facility.

FIG. 8 is a view showing a connection relationship between a second liquid pipe and a shell of a second evaporator in another modification of the offshore floating facility.

FIG. 9 is a view for describing an arrangement of an intermediate fluid evaporator and a second evaporator in a modification of the offshore floating facility.

FIG. 10 is a view for describing an arrangement of an intermediate fluid evaporator and a second evaporator in another modification of the offshore floating facility.

FIG. 11 is a view for describing an arrangement of an intermediate fluid evaporator and a second evaporator in still another modification of the offshore floating facility.

FIG. 12 is a view for describing an arrangement of an intermediate fluid evaporator and a second evaporator in still another modification of the offshore floating facility.

FIG. 13 is a view for describing an arrangement of an intermediate fluid evaporator and a second evaporator in still another modification of the offshore floating facility.

FIG. 14 is a view for describing an arrangement of an intermediate fluid evaporator and a second evaporator in still another modification of the offshore floating facility.

FIG. 15 is a view schematically showing an offshore floating facility according to another embodiment of the present invention.

FIG. 16 is a view showing a configuration of a conventional intermediate fluid type vaporizer.

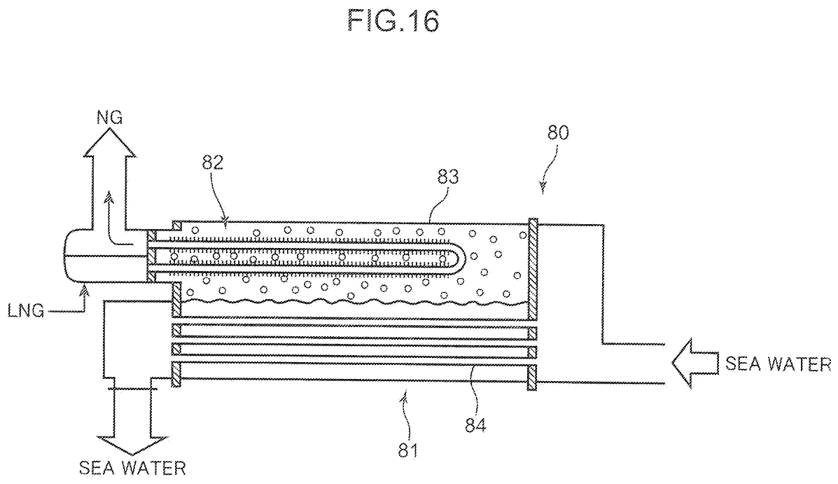

### DESCRIPTION OF EMBODIMENTS

Hereinafter, a mode for carrying out the present invention is described in detail with reference to the drawings.

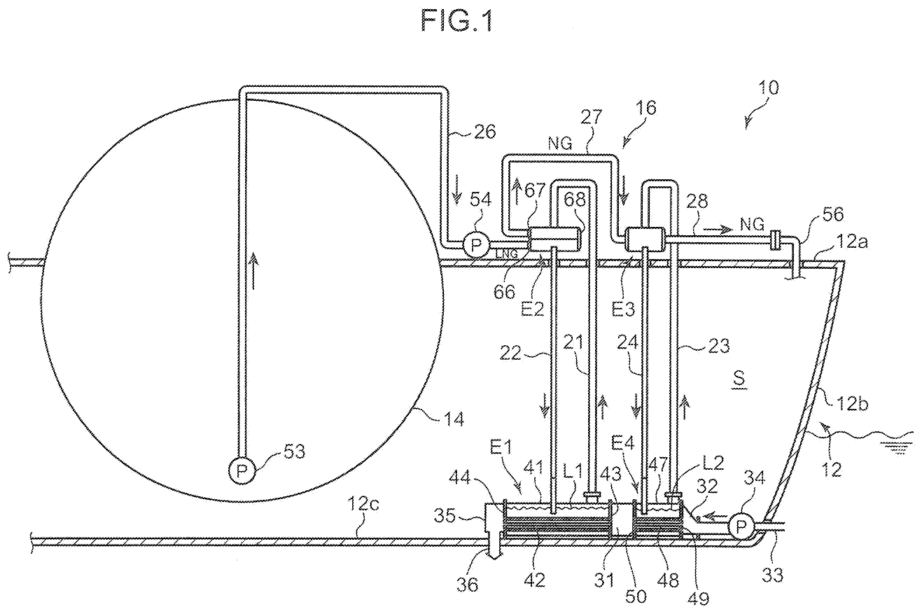

As shown in FIG. 1, an offshore floating facility 10 according to this embodiment is formed as a floating storage and regasification unit (FSRU) moored in sea. That is, the offshore floating facility 10 includes: a hull 12; a tank 14 which is disposed on the hull 12, receives the supply of a liquefied natural gas (LNG) from an LNG tanker, and stores the LNG; and an intermediate fluid type vaporizer 16 which is disposed on the hull 12, and vaporizes the LNG stored in the tank 14.

The hull 12 includes: a deck 12a which is disposed to extend horizontally; a side wall portion 12b which extends downward from a peripheral edge portion of the deck 12a; and a hull bottom 12c which is connected to a lower edge of the side wall portion 12b. A space S which is formed in the hull 12 and is surrounded by the deck 12a, the side wall portion 12b, and the hull bottom 12c may be partitioned into a plurality of spaces by partition walls not shown in the drawing.

The deck 12a is one of strength members which form the hull 12, and forms an upper lid as a ceiling portion of a space in the hull 12. The deck 12a also functions as a floor plate for a superstructure, not shown in the drawing, which is installed on the deck 12a. The superstructure may include a mooring device or the like, for example. The side wall portion 12b includes: an outer plate (not shown in the drawing); and a frame (not shown in the drawing) which is disposed along an inner surface of the outer plate and serves as a strength member. In FIG. 1, the side wall portion 12b is shown in cross section as a single plate member for the sake of convenience. The hull bottom 12c is a portion which forms a lower surface of the hull 12. The hull bottom 12c includes: an outer plate (not shown in the drawing); a frame (not shown in the drawing) which is disposed along an inner surface of the outer plate and serves as a strength member; and an inner bottom plate (not shown in the drawing) which is fixed to an inner side of the frame. A ballast tank may be formed on the hull bottom 12c. In FIG. 1, the hull bottom 12c is shown in cross section as a single plate member for the sake of convenience.

The tank 14 has a size extending from the space S surrounded by the deck 12a, the side wall portion 12b and the hull bottom 12c to an upper side of the deck 12a. In the tank 14, an LNG conveyed by an LNG tanker is stored. In the tank 14, an inner-tank pump 53 for pumping up an LNG is disposed. Although a spherical tank is exemplified as the tank 14 in FIG. 1, the shape of the tank 14 is not limited to a spherical shape, and may be a rectangular parallelepiped shape, for example.

The intermediate fluid type vaporizer (hereinafter simply referred to as “vaporizer”) 16 is a device where heat of sea water which forms a heat source medium is transferred to an LNG which is a low-temperature liquefied gas through an intermediate fluid so that the LNG is vaporized and a natural gas (NG) is obtained. As the intermediate fluid, for example, propane, alternative chlorofluorocarbon (R401A, R32) or the like can be used. Alternative chlorofluorocarbon exhibits lower combustibility than propane and hence, a risk of alternative chlorofluorocarbon when leaked is lower than a risk of propane when leaked. The vaporizer 16 may be formed as a device for vaporizing a low-temperature liquefied gas other than an LNG such as a liquefied petroleum gas (LPG) or liquid nitrogen (LN2).

The vaporizer 16 includes: an intermediate fluid evaporator E1 which serves as an intermediate fluid evaporating part; an LNG evaporator E2 which serves as a liquefied gas vaporizing part; a first gas pipe 21; a first liquid pipe 22; a second evaporator E4 which serves as a second intermediate fluid evaporating part; a heater E3 which serves as a gas heater; a second gas pipe 23; a second liquid pipe 24; an introduction pipe 26; a connection pipe 27; and a discharge pipe 28.

The intermediate fluid evaporator E1 and the second evaporator E4 are mounted on the inner bottom plate of the hull bottom 12c, and the LNG evaporator E2 and the heater E3 are mounted on the deck 12a. The intermediate fluid evaporator E1 and the LNG evaporator E2 are joined to each other by the first gas pipe 21 and the first liquid pipe 22. A circulation circuit through which an intermediate fluid circulates is formed of the intermediate fluid evaporator E1, the LNG evaporator E2, the first gas pipe 21, and the first liquid pipe 22. The difference in height between a mounting position of the intermediate fluid evaporator E1 and a mounting position of the LNG evaporator E2 is set to 10 m or more, for example. The LNG evaporator E2 and the heater E3 are disposed above the deck 12a and hence, even when an LNG or an NG is leaked from the LNG evaporator E2 and the heater E3, it is possible to prevent the LNG or the NG from stagnating in the space S of the hull 12.

The second evaporator E4 and the heater E3 are joined to each other by the second gas pipe 23 and the second liquid pipe 24. A second circulation circuit through which the intermediate fluid circulates is formed of the second evaporator E4, the heater E3, the second gas pipe 23, and the second liquid pipe 24. The difference in height between a mounting position of the second evaporator E4 and a mounting position of the heater E3 is set to 10 m or more, for example.

The second evaporator E4 is disposed on a lateral side of the intermediate fluid evaporator E1, and an intermediate chamber 31 is formed between the intermediate fluid evaporator E1 and the second evaporator E4. A lead-in chamber 32 into which sea water is introduced is formed on a side of the second evaporator E4 opposite to the intermediate chamber 31. A lead-in pipe 33 which penetrates the hull bottom 12c or the side wall portion 12b in the vicinity of the hull bottom 12c is connected to the lead-in chamber 32, and a pump 34 for pumping up sea water is mounted on the lead-in pipe 33. Sea water which is sucked into the lead-in pipe 33 by the pump 34 as a heat source fluid is introduced into the second evaporator E4 through the lead-in pipe 33 and the lead-in chamber 32.

In the intermediate chamber 31, sea water which passes through the second evaporator E4 is stored. Sea water in the intermediate chamber 31 is introduced into the intermediate fluid evaporator E1. A lead-out chamber 35 for discharging sea water is formed on a side of the intermediate fluid evaporator E1 opposite to the intermediate chamber 31. A lead-out pipe 36 which penetrates the hull bottom 12c or the side wall portion 12b in the vicinity of the hull bottom 12c is connected to the lead-out chamber 35. Sea water which passes through the intermediate fluid evaporator E1 is discharged to the outside of the ship through the lead-out chamber 35 and the lead-out pipe 36.

The intermediate fluid evaporator E1 has a shell 41, and a large number of heat transfer tubes 42. In the shell 41, an intermediate fluid having a lower boiling point than a temperature of sea water (first intermediate fluid, for example, propane) is stored. The intermediate fluid is stored in the shell 41 to the extent that a liquid surface L1 of the intermediate fluid is positioned above all heat transfer tubes 42.

A lower end portion of the first gas pipe 21 is connected to a ceiling portion of the shell 41. The lower end portion of the first gas pipe 21, that is, an inlet port of the first gas pipe 21 for the intermediate fluid is positioned above the liquid surface L1. An opening on the lower end of the first gas pipe 21 is not brought into contact with the liquid surface L1 of the intermediate fluid in a liquid form. Accordingly, it is possible to prevent the inlet port of the first gas pipe 21 from being closed by the intermediate fluid in a liquid form.

The first liquid pipe 22 penetrates the celling portion of the shell 41. A lower end portion of the first liquid pipe 22, that is, an outlet port of the first liquid pipe 22 for the intermediate fluid in a liquid form is positioned below the liquid surface L1 of the intermediate fluid stored in the shell 41. That is, the outlet port of the first liquid pipe 22 for the intermediate fluid is positioned in the intermediate fluid in a liquid form stored in the shell 41. With such a configuration, the first liquid pipe 22 can be liquid-sealed such that an intermediate fluid in a gaseous form cannot be sucked into the first liquid pipe 22 from the lower end portion of the first liquid pipe 22. There is a possibility that a height of the liquid surface L1 changes when the hull 12 rolls. However, in the case where the liquid surface L1 rolls to the extent that the heat transfer tubes 42 are not exposed, the lower end portion of the first liquid pipe 22 can be liquid-sealed.

Side walls which form both ends of the shell 41 in a longitudinal direction are formed of tube sheets 43, 44 respectively, and the heat transfer tubes 42 are extended between the tube sheets 43, 44. One tube sheet 43 functions also as a partition wall between the intermediate chamber 31 and the intermediate fluid evaporator E1. The other tube sheet 44 functions also as a partition wall between the intermediate fluid evaporator E1 and the lead-out chamber 35. Although the heat transfer tube 42 has a shape extending straightly in one direction, the heat transfer tube 42 is not limited to such a shape. The inside of the heat transfer tube 42 is communicated with the intermediate chamber 31 and the lead-out chamber 35.

The second evaporator E4 has a shell 47 and a large number of heat transfer tubes 48. In the shell 47, a second intermediate fluid having a lower boiling point than a temperature of sea water (for example, propane) is stored. The intermediate fluid is stored in the shell 47 to the extent that a liquid surface L2 is positioned above all heat transfer tubes 48. The second intermediate fluid may be the same kind of intermediate fluid as the first intermediate fluid stored in the shell 41 of the intermediate fluid evaporator E1, or may be a kind of intermediate fluid different from the first intermediate fluid stored in the shell 41 of the intermediate fluid evaporator E1.

A lower end portion of the second gas pipe 23 is connected to a ceiling portion of the shell 47. The lower end portion of the second gas pipe 23, that is, an inlet port of the second gas pipe 23 for the second intermediate fluid is positioned above the liquid surface L2. An opening on the lower end of the second gas pipe 23 is not brought into contact with the liquid surface L2 of the second intermediate fluid in a liquid form. Accordingly, it is possible to prevent the inlet port from being closed by the intermediate fluid in a liquid form.

The second liquid pipe 24 penetrates the ceiling portion of the shell 47. A lower end portion of the second liquid pipe 24 is positioned below the liquid surface L2 of the second intermediate fluid stored in the shell 47. With such a configuration, the second liquid pipe 24 can be liquid-sealed such that the second intermediate fluid in a gaseous form cannot be sucked into the second liquid pipe 24 from the lower end portion of the second liquid pipe 24.

The side walls which form both ends of the shell 47 in a longitudinal direction are formed of tube sheets 49, 50 respectively, and the heat transfer tubes 48 are extended between the tube sheets 49, 50. Although the heat transfer tube 48 has a shape extending straightly in one direction, the heat transfer tube 48 is not limited to such a shape. One tube sheet 49 functions as a partition wall between the lead-in chamber 32 and the second evaporator E4, and the other tube sheet 50 functions as a partition wall between the second evaporator E4 and the intermediate chamber 31. The inside of the heat transfer tube 48 is communicated with the lead-in chamber 32 and the intermediate chamber 31.

In this embodiment, the shell 41 of the intermediate fluid evaporator E1, the outer wall of the intermediate chamber 31, and the shell 47 of the second evaporator E4 are joined to each other and are arranged in series. However, the present invention is not limited to such a configuration, and the intermediate fluid evaporator E1, the intermediate chamber 31, and the second evaporator E4 may be provided independently from each other.

The first gas pipe 21 is connected to a ceiling portion of the LNG evaporator E2, and the first liquid pipe 22 is connected to a bottom portion of the LNG evaporator E2.

One end portion of the introduction pipe 26 is connected to the inner-tank pump 53, and the other end portion of the introduction pipe 26 is connected to the LNG evaporator E2. A booster pump 54 is provided to the introduction pipe 26. The booster pump 54 is provided for boosting a pressure of an LNG sucked by the inner-tank pump 53. Since a pressure of the LNG is boosted by the booster pump 54, an NG can be discharged from the discharge pipe 28 at a prescribed pressure for supplying the NG to the pipe line 56.

One end portion of the connection pipe 27 is connected to the LNG evaporator E2, and the other end portion of the connection pipe 27 is connected to the heater E3.

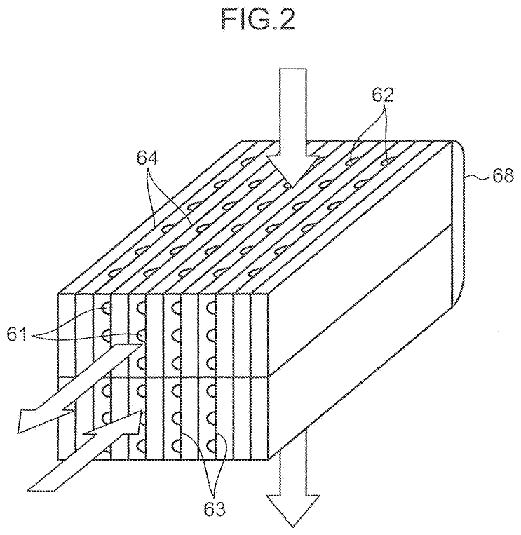

The LNG evaporator E2 is formed of a stacked-type heat exchanger. For example, as schematically shown in FIG. 2, the LNG evaporator E2 has a stacked body in which first flow passages 61 and second flow passages 62 are formed. The stacked body is formed by alternately stacking: first metal plates 63 each having one surface on which the groove-shaped first flow passages 61 are formed; and second metal plates 64 each having one surface on which the groove-shaped second flow passages 62 are formed. The LNG evaporator E2 may be formed of a microchannel heat exchanger where the first metal plates 63 and the second metal plates 64 are integrally joined to each other by diffusion bonding. The first flow passages 61 are communicated with the introduction pipe 26 and the connection pipe 27. Accordingly, an LNG is introduced into the first flow passages 61. On the other hand, the second flow passages 62 are communicated with the first gas pipe 21 and the first liquid pipe 22. Accordingly, an intermediate fluid in a gaseous form is introduced into the second flow passages 62 from upper ends of the second flow passages 62. A heat exchange is performed between the LNG in the first flow passages 61 and the intermediate fluid in the second flow passages 62. The LNG is heated and converted into an NG, while the intermediate fluid in a gaseous form is cooled and condensed.

The first flow passages 61 are formed such that the first flow passages 61 extend within a horizontal plane, for example. On the other hand, the second flow passages 62 are formed such that the second flow passages 62 extend within a vertical plane, for example. Accordingly, the intermediate fluid condensed in the second flow passages 62 easily flows down into the first liquid pipe 22 from lower end portions of the second flow passages 62.

In this embodiment, an inlet header 66 which is connected to the introduction pipe 26 and an outlet header 67 which is connected to the connection pipe 27 are formed on the same side of the LNG evaporator E2. However, the present invention is not limited to such a configuration. That is, in this embodiment, the LNG evaporator E2 includes a communication header 68 which makes the first flow passages 61 disposed on an upper side and the first flow passages 61 disposed on a lower side communicate with each other thus forming a two-path configuration. Accordingly, the inlet header 66 and the outlet header 67 are disposed on the same side. Alternatively, a configuration may be adopted where the LNG evaporator E2 does not include the communication header 68, and the inlet header 66 and the outlet header 67 are disposed on sides opposite to each other.

The second gas pipe 23 is connected to a ceiling portion of the heater E3, and the second liquid pipe 24 is connected to a bottom portion of the heater E3. One end portion of the connection pipe 27 is connected to the heater E3. One end portion of the discharge pipe 28 is connected to the heater E3, and the other end portion of the discharge pipe 28 is connected to a connection port of the pipe line 56. The pipe line 56 penetrates the hull 12 and extends to the outside of the hull 12.

All of a portion of the introduction pipe 26 which is disposed outside the tank 14, the connection pipe 27, and the discharge pipe 28 are disposed above the deck 12a. However, some of these parts may protrude into an area below the deck 12a or may be disposed only on an upper side of the deck 12a. That is, pipes through which an LNG flows and pipes through which an NG flows are mainly disposed above the deck 12a and hence, it is possible to prevent the pipes through which the LNG and the NG flows from becoming long.

The heater E3 is formed of a stacked-type heat exchanger. That is, the heater E3 has a stacked body in which first flow passages and second flow passages are formed. Although not shown in the drawing, in the same manner as the stacked body which forms the LNG evaporator E2, the stacked body is formed by alternately stacking: first metal plates each having one surface on which the groove-shaped first flow passages are formed; and second metal plates each having one surface on which the groove-shaped second flow passages are formed. The first flow passages are communicated with the connection pipe 27 and the discharge pipe 28. Accordingly, an NG is introduced into the first flow passages. The second flow passages are communicated with second gas pipe 23 and the second liquid pipe 24. Accordingly, a second intermediate fluid in a gaseous form is introduced into the second flow passages from upper ends of the second flow passages. A heat exchange is performed between the NG in the first flow passages and the second intermediate fluid in the second flow passages. The NG is heated, while the intermediate fluid in a gaseous form is cooled and condensed.

The first flow passages are formed such that the first flow passages extend within a horizontal plane, for example, and the second flow passages are formed such that the second flow passages extend within a vertical plane, for example. Accordingly, the second intermediate fluid condensed in the second flow passages easily flows and falls into the second liquid pipe 24 from lower end portions of the second flow passages. The heater E3 may be formed of a microchannel heat exchanger where the first metal plates and the second metal plates are integrally joined to each other by diffusion bonding.

The manner of operation of the vaporizer 16 is described hereinafter. In the intermediate fluid evaporator E1, sea water in the intermediate chamber 31 flows into the heat transfer tubes 42. With such an operation, an intermediate fluid in the shell 41 is evaporated. Sea water which passes through the heat transfer tubes 42 is discharged to the outside of the ship after passing through the lead-out chamber 35 and the lead-out pipe 36.

The intermediate fluid evaporated in the intermediate fluid evaporator E1 is elevated in the first gas pipe 21, and flows into the LNG evaporator E2 from the ceiling portion of the LNG evaporator E2. On the other hand, due to an operation of the inner-tank pump 53 and an operation of the booster pump 54, an LNG in the tank 14 flows into the LNG evaporator E2 through the introduction pipe 26. In the LNG evaporator E2, the LNG is introduced into the first flow passages 61 from the introduction pipe 26 and, at the same time, the intermediate fluid in a gaseous form is introduced into the second flow passages 62 from the first gas pipe 21. A heat exchange is performed between the LNG which flows through the first flow passages 61 and the intermediate fluid which flows through the second flow passages 62 and hence, the LNG is evaporated, while the intermediate fluid is condensed. The intermediate fluid in a liquid form which is condensed in the LNG evaporator E2 flows down through the first liquid pipe 22 from the bottom portion of the LNG evaporator E2, and returns to the inside of the shell 41 of the intermediate fluid evaporator E1. On the other hand, the NG in the first flow passages 61 flows into the connection pipe 27.

The LNG evaporator E2 and the intermediate fluid evaporator E1 are disposed in a spaced apart manner from each other with a sufficient distance therebetween and hence, there is no possibility that the first liquid pipe 22 is completely filled with the intermediate fluid in a liquid form. Accordingly, an intermediate fluid in a liquid form flows down from the LNG evaporator E2 with certainty. Then, a head pressure according to an amount of the intermediate fluid in a liquid form stored in the first liquid pipe 22 is applied to the intermediate fluid in the shell 41. Such a pressure and a suction force generated by the condensation of the intermediate fluid in the LNG evaporator E2 act as a driving force for naturally circulating the intermediate fluid. Accordingly, the natural circulation of the intermediate fluid between the LNG evaporator E2 and the intermediate fluid evaporator E1 can be generated with certainty.

In the second evaporator E4, sea water is introduced into the heat transfer tubes 48 through the lead-in pipe 33 and the lead-in chamber 32 due to an operation of the pump 34. With such an operation, a second intermediate fluid in the shell 47 is evaporated and is elevated in the second gas pipe 23. Sea water in the heat transfer tubes 48 is introduced into the intermediate chamber 31.

The second intermediate fluid which is elevated in the second gas pipe 23 flows into the heater E3 from the ceiling portion of the heater E3. On the other hand, an NG also flows from the connection pipe 27 into the heater E3. In the heater E3, the NG is introduced into the first flow passages from the connection pipe 27 and, at the same time, the second intermediate fluid in a gaseous form is introduced into the second flow passages from the second gas pipe 23. A heat exchange is performed between the NG which flows through the first flow passages and the second intermediate fluid which flows through the second flow passages and hence, the NG is heated, while the second intermediate fluid is condensed. The second intermediate fluid in a liquid form which is condensed in the heater E3 flows down through the second liquid pipe 24 from the bottom portion of the heater E3, and returns to the inside of the shell 47 of the second evaporator E4. On the other hand, the NG heated in the first flow passages is fed to the pipe line 56 through the discharge pipe 28.

The heater E3 and the second evaporator E4 are disposed in a spaced apart manner from each other with a sufficient distance therebetween and hence, there is no possibility that the second liquid pipe 24 is completely filled with the second intermediate fluid in a liquid form. Accordingly, the second intermediate fluid in a liquid form flows down from the heater E3 with certainty. Then, a head pressure according to an amount of the second intermediate fluid in a liquid form stored in the second liquid pipe 24 is applied to the second intermediate fluid in the shell 47. Such a pressure and a suction force generated by the condensation of the second intermediate fluid in the heater E3 act as a driving force for naturally circulating the second intermediate fluid. Accordingly, the natural circulation of the second intermediate fluid between the heater E3 and the second evaporator E4 can be generated with certainty.

In the offshore floating facility 10, the deck 12a is positioned at a place higher than a sea level. However, in this embodiment, the intermediate fluid evaporator E1 is disposed below the deck 12a and hence, a pumping power required for feeding sea water to the intermediate fluid evaporator E1 can be reduced compared to a case where the intermediate fluid evaporator E1 is disposed above the deck 12a. On the other hand, the LNG evaporator E2 positioned above the deck 12a and the intermediate fluid evaporator E1 positioned below the deck 12a are connected to each other by the first gas pipe 21 and the first liquid pipe 22 and hence, the pipes may be elongated. However, in the offshore floating facility 10, a running cost for generating pumping power can be reduced and hence, a cost incurred by the elongation of the pipes can be offset. Further, the LNG evaporator E2 is disposed above the deck 12a and hence, it is unnecessary to extend the pipe through which a low-temperature liquefied gas flows from above the deck 12a to below the deck 12a.

A distance between the LNG evaporator E2 and the intermediate fluid evaporator E1 can be increased and hence, it is possible to avoid the occurrence of a situation where the intermediate fluid in a liquid form is stored in the whole first liquid pipe 22 and, further, it is possible to ensure a head of the condensed intermediate fluid. Accordingly, the natural circulation of the intermediate fluid can be generated with certainty.

The intermediate fluid evaporator E1 is disposed on the hull bottom 12c of the hull 12, and the hull bottom 12c is positioned below the sea level. Accordingly, pumping power required for feeding sea water to the intermediate fluid evaporator E1 can be further reduced. A distance between the LNG evaporator E2 and the intermediate fluid evaporator E1 can be further increased and hence, a head of the condensed intermediate fluid can be ensured more easily whereby a driving force for circulating the intermediate fluid can be easily acquired.

The intermediate fluid evaporator E1 is disposed on the hull bottom 12c and hence, even when the hull 12 rolls, a rolling width of the intermediate fluid evaporator E1 per se can be suppressed. Accordingly, compared to a case where the intermediate fluid evaporator E1 is disposed above the deck 12a, a change in a liquid surface of the intermediate fluid in a liquid form stored in the intermediate fluid evaporator E1 can be suppressed. Further, the intermediate fluid evaporator E1 is disposed on the hull bottom 12c and hence, the intermediate fluid evaporator E1 can contribute to the stabilization of the hull 12.

In this embodiment, the second evaporator E4 which uses sea water as a heat source is disposed below the deck 12a and hence, pumping power required for feeding sea water to the second evaporator E4 can be reduced compared to a case where the second evaporator E4 is disposed on the deck 12a. On the other hand, the heater E3 and the second evaporator E4 are connected to each other by the second gas pipe 23 and the second liquid pipe 24 and hence, the pipes may be elongated. However, in the offshore floating facility 10, a running cost for generating pumping power can be reduced and hence, a cost incurred by the elongation of the pipe length can be offset. Further, both the LNG evaporator E2 and the heater E3 are disposed above the deck 12a and hence, it is sufficient that pipes provided for feeding a liquefied gas or a gas to the LNG evaporator E2 and the heater E3 are routed around on the deck 12a. Accordingly, it is possible to prevent the piping configuration from becoming complicated.

A distance between the heater E3 and the second evaporator E4 can be increased and hence, a head of the condensed intermediate fluid can be easily ensured so that a driving force for circulating the intermediate fluid can be easily acquired. As a result, it is possible to avoid the occurrence of a situation where the intermediate fluid in a liquid form is stored in the whole liquid pipe. Accordingly, the natural circulation of the second intermediate fluid can be easily generated.

The second evaporator E4 is disposed on the hull bottom 12c and hence, even when the hull 12 rolls, a rolling width of the second evaporator E4 per se can be suppressed. Accordingly, compared to the case where the second evaporator E4 is disposed above the deck 12a, a change in a liquid surface of the second intermediate fluid in a liquid form stored in the second evaporator E4 can be suppressed. Further, the second evaporator E4 is disposed on the hull bottom 12 and hence, the second evaporator E4 can contribute to the stabilization of the hull 12.

The present invention is not limited to the above-mentioned embodiment, and various modifications, improvements and the like are conceivable without departing from the gist of the present invention. For example, in the embodiment, the offshore floating facility 10 adopts the configuration where the offshore floating facility 10 includes the tank 14 mounted on the hull 12. However, the present invention is not limited to such a configuration. For example, the offshore floating facility 10 may adopt a configuration where the tank 14 is omitted, and the intermediate fluid type vaporizer 16 vaporizes an LNG which is directly supplied to the intermediate fluid type vaporizer 16 from an LNG tanker.

The LNG evaporator E2 may be formed of a shell-and-tube-type heat exchanger. In this case, an intermediate fluid in a gaseous form which is introduced through the first gas pipe 21 enters a shell, and a high-pressure LNG which is introduced through the introduction pipe 26 flows into heat transfer tubes. Then, a heat exchange is performed between the intermediate fluid in the shell and the LNG in the heat transfer tubes, and the intermediate fluid condensed in the shell flows down through the first liquid pipe 22.

The heater E3 may be formed of a shell-and-tube-type heat exchanger. In this case, a second intermediate fluid in a gaseous form which is introduced through the second gas pipe 23 enters a shell, and a high-pressure NG which is introduced through the connection pipe 27 flows into heat transfer tubes. Then, a heat exchange is performed between the second intermediate fluid in the shell and the NG in the heat transfer tubes, and the second intermediate fluid condensed in the shell flows down through the second liquid pipe 24.

For example, the LNG evaporator E2 or the heater E3 may be formed of a plate fin heat exchanger where a large number of metal plates each of which is formed into a corrugated shape are stacked to each other, and spaces each formed between the neighboring metal plates are formed as the first flow passages 61 and the second flow passages 62 respectively.

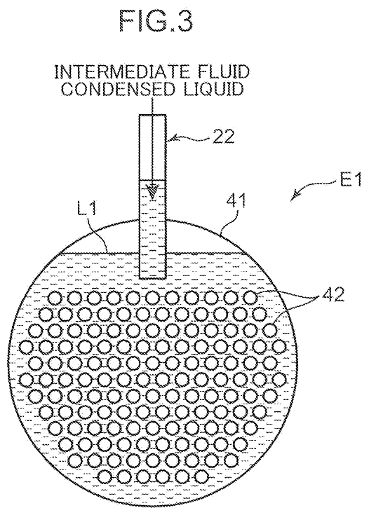

In the above-mentioned embodiment, as shown also in FIG. 3, although the lower end portion (the outflow port for the intermediate fluid) of the first liquid pipe 22 is positioned above the heat transfer tubes 42 of the intermediate fluid evaporator E1, the outflow port for the intermediate fluid is positioned in the intermediate fluid in a liquid form which is stored in the shell 41 of the intermediate fluid evaporator E1. That is, the outflow port of the first liquid pipe 22 for the intermediate fluid is positioned above the heat transfer tubes 42 which are disposed at an uppermost position out of a group of heat transfer tubes formed of the large number of heat transfer tubes 42. Accordingly, a low-temperature intermediate fluid which flows downward in the first liquid pipe 22 and flows out from the lower end portion of the first liquid pipe 22 is brought into contact with the intermediate fluid in a liquid form stored in the shell 41 and hence, there is no possibility that the low-temperature intermediate fluid directly impinges on the heat transfer tubes 42. Accordingly, even when the intermediate fluid which flows downward in the first liquid pipe 22 has an extremely low temperature, it is possible to avoid the occurrence of a situation where the heat transfer tubes 42 are rapidly cooled. In the case where the offshore floating facility FSRU is anchored on a seacoast, although there may be a case where the hull 12 rolls, it is estimated that the rolling of the hull 12 is not so large. Accordingly, even when the outflow port of the first liquid pipe 22 for the intermediate fluid is positioned above the heat transfer tubes 42, it is possible to easily maintain a state where the lower end opening of the first liquid pipe 22 is liquid-sealed by the intermediate fluid in the shell 41.

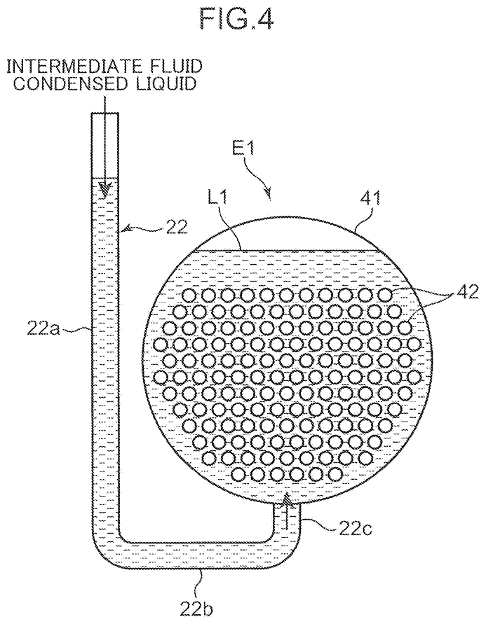

The position of the lower end portion of the first liquid pipe 22 is not limited to such a position. For example, as shown in FIG. 4, the outflow port of the first liquid pipe 22 for the intermediate fluid may be positioned below the heat transfer tubes 42. In this case, the end portion of the first liquid pipe 22 is connected to a lower end portion of the shell 41, for example. In such a configuration, the first liquid pipe 22 has: a portion 22a which passes along the side of the shell 41 in a vertical direction, a portion 22b which extends sideward from a lower end of the portion 22a; and a portion 22c which extends upward from an end portion of the portion 22b and is connected to the lower end portion of the shell 41. In this case, the shell 41 is supported on an inner bottom plate of the hull bottom 12c by a supporting base not shown in the drawing such that a space which allows the portions 22b, 22c of the first liquid pipe 22 to pass through the space is formed between the shell 41 and the inner bottom plate of the hull bottom 12c. In such a configuration where the outflow port of the first liquid pipe 22 for the intermediate fluid is positioned below the heat transfer tubes 42, even when the hull 12 rolls to the extent that most of the heat transfer tubes 42 out of the large number of heat transfer tubes 42 are exposed, a state where the first liquid pipe 22 is liquid-sealed can be maintained. Accordingly, even when most of the heat transfer tubes 42 out of the large number of heat transfer tubes 42 are exposed from a liquid surface, it is possible to prevent the low-temperature intermediate fluid which flows downward through the first liquid pipe 22 from directly impinging on the heat transfer tubes 42 without coming into contact with the intermediate fluid in a liquid form stored in the intermediate fluid evaporator E1. Accordingly, it is possible to prevent freezing of sea water in the heat transfer tubes 42.

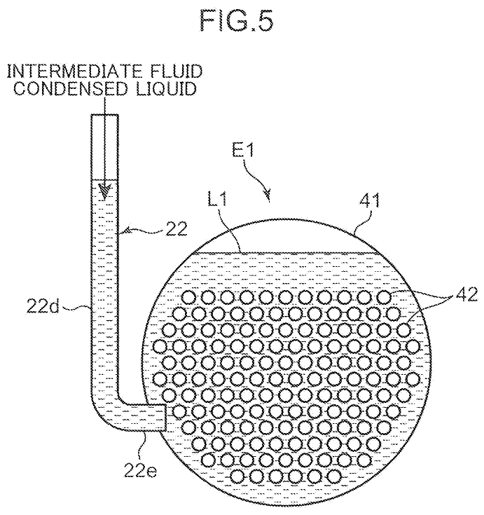

As shown in FIG. 5, the outflow port of the first liquid pipe 22 for the intermediate fluid may be positioned below the heat transfer tubes 42 disposed at an uppermost position and above the heat transfer tubes 42 disposed at a lowermost position. That is, the outflow port of the first liquid pipe 22 for the intermediate fluid may be positioned at the same height as the group of heat transfer tubes.

In this case, the first liquid pipe 22 has: a portion 22d which extends along a side of the shell 41 in a vertical direction; and a portion 22e which extends sideward from a lower end of the portion 22d and is connected to a side portion of the shell 41.

In such a configuration, the first liquid pipe 22 can be liquid-sealed such that an intermediate fluid in a gaseous form does not flow into the first liquid pipe 22 from the outflow port for the intermediate fluid in a liquid form. Further, even when the hull 12 rolls, so long as a height of the liquid surface L1 of the intermediate fluid changes to the extent that the heat transfer tubes 42 disposed at an uppermost position out of the large number of heat transfer tubes 42 are exposed, a state where the first liquid pipe 22 is liquid-sealed can be maintained. Accordingly, even when the heat transfer tubes 42 disposed at an uppermost position out of the large number of heat transfer tubes 42 are exposed from the liquid surface, it is possible to prevent the low-temperature intermediate fluid which flows downward through the first liquid pipe 22 from directly impinging on the heat transfer tubes 42 without coming into contact with the intermediate fluid in a liquid form stored in the intermediate fluid evaporator E1. Accordingly, it is possible to prevent freezing of sea water in the heat transfer tube 42.

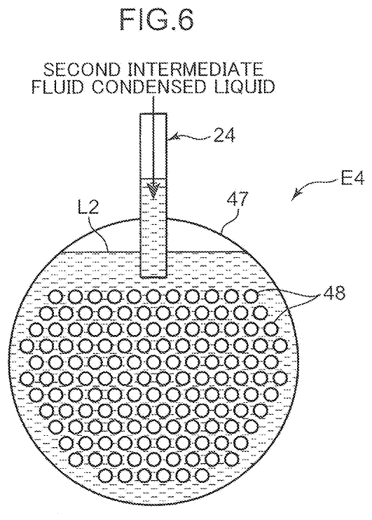

FIG. 3 to FIG. 5 show the connection relationships between the intermediate fluid evaporator E1 and the first liquid pipe 22. However, such connection relationships may be adopted with respect to the connection relationship between the second evaporator E4 and the second liquid pipe 24. That is, as shown in FIG. 6, the lower end portion (the outflow port of the second intermediate fluid) of the second liquid pipe 24 may be positioned above the heat transfer tubes 48 of the second evaporator E4. That is, the second liquid pipe 24 may be formed such that the second liquid pipe 24 penetrates the ceiling portion of the shell 47, and the outflow port of the second liquid pipe 24 for the second intermediate fluid may be positioned above the heat transfer tubes 48 which are disposed at an uppermost position out of a group of heat transfer tubes formed of the large number of heat transfer tubes 48.

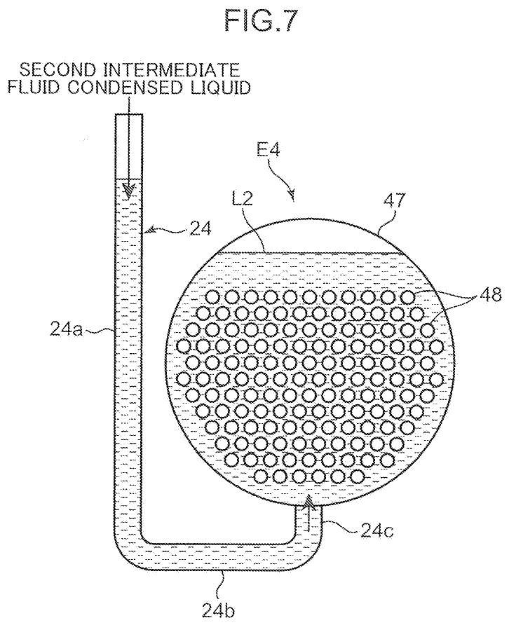

As shown in FIG. 7, the outflow port of the second liquid pipe 24 for the second intermediate fluid may be positioned below a group of heat transfer tubes formed of the large number of heat transfer tubes 48. In this case, the end portion of the second liquid pipe 24 is connected to the lower end portion of the shell 47, for example, and hence, the second liquid pipe 24 has a portion 24a which passes along a side of the shell 47 in the vertical direction, a portion 24b which extends sideward from a lower end of the portion 24a, and a portion 24c which extends upward from an end portion of the portion 24b and is connected to the lower end portion of the shell 47. In this case, the shell 47 is supported on the inner bottom plate of the hull bottom 12c by a supporting base not shown in the drawing such that a space which allows the portions 24b, 24c of the second liquid pipe 24 to pass through the space is formed between the shell 47 and the inner bottom plate of the hull bottom 12c.

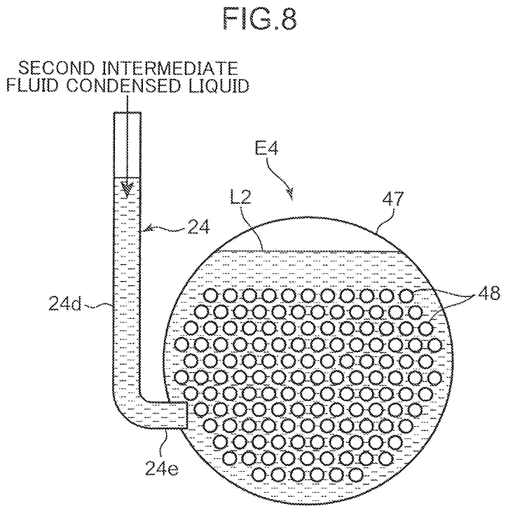

As shown in FIG. 8, the outflow port of the second liquid pipe 24 for the second intermediate fluid may be positioned below the heat transfer tubes 48 disposed at an uppermost position out of the group of heat transfer tubes and above the heat transfer tubes 48 disposed at a lowermost position out of the group of heat transfer tubes. That is, the outflow port of the second liquid pipe 24 for the second intermediate fluid may be positioned at the same height as the group of heat transfer tubes. In this case, the second liquid pipe 24 has a portion 24d which extends along the side of the shell 47 in the vertical direction, and a portion 24e which extends sideward from a lower end of the portion 24d and is connected to the shell 47.

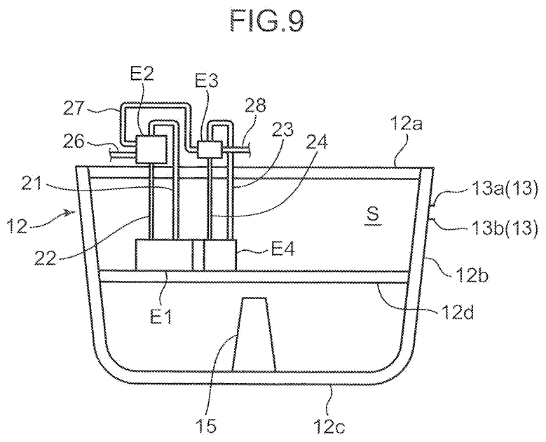

In the above-mentioned embodiment, the intermediate fluid evaporator E1 is disposed on the hull bottom 12c. However, the present invention is not limited to such a configuration. For example, so long as the intermediate fluid evaporator E1 is positioned below the deck 12a, the intermediate fluid evaporator E1 may be positioned above the hull bottom 12c. For example, as shown in FIG. 9, in the case where an intermediate floor 12d is disposed above the hull bottom 12c in the space S in the hull 12, the intermediate fluid evaporator E1 and the second evaporator E4 may be disposed on the intermediate floor 12d. The intermediate floor 12d may be disposed above an engine 15 which generates a driving force for acquiring a propulsive force of the hull 12, or may be positioned at the same height as the engine 15.

Also in the case where the intermediate fluid evaporator E1 and the second evaporator E4 are mounted on the intermediate floor 12d, it is preferable that the intermediate fluid evaporator E1 and the second evaporator E4 be positioned below a load line 13 of the hull 12. The load line 13 means a mark indicating an upper limit in load weight which can maintain a safely floating state of the hull 12. The load line 13 indicates a draft of the hull 12 in a fully loaded state. The load line 13 includes various lines such as a deepest allowable waterline for a tropical sea area, a deepest allowable waterline for summer, a deepest allowable waterline for winter, and the like. It is preferable that the intermediate fluid evaporator E1 and the second evaporator E4 be positioned below the load line 13 whichever waterline is adopted as the load line 13. FIG. 9 shows a case where the deepest allowable waterline 13a for summer and the deepest allowable waterline 13b for winter are formed on the hull 12. In this case, it is preferable that the intermediate fluid evaporator E1 and the second evaporator E4 be positioned below both waterlines 13a, 13b.

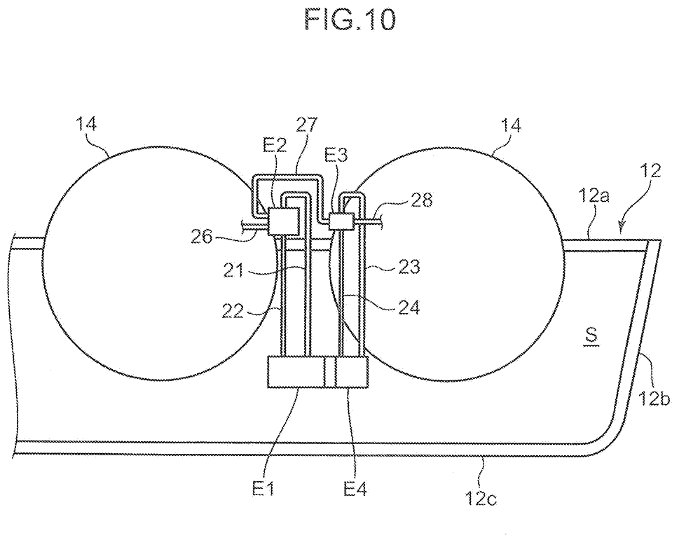

In the case where the plurality of tanks 14 are disposed in the space S of the hull 12, the intermediate fluid evaporator E1 and the second evaporator E4 may be disposed in a gap formed between the tanks 14 disposed adjacently to each other. That is, as shown in FIG. 10, each tank 14 is formed into a spherical shape. Accordingly, a dead space is likely to be formed in the space S between the tanks 14 disposed adjacently to each other at the position below the position where each tank 14 takes a maximum width. The intermediate fluid evaporator E1 and the second evaporator E4 may be disposed by making use of the dead space. In this case, the intermediate fluid evaporator E1 and the second evaporator E4 may be supported on the hull bottom 12c, or may be supported on a floor disposed in the space S other than the hull bottom 12c.

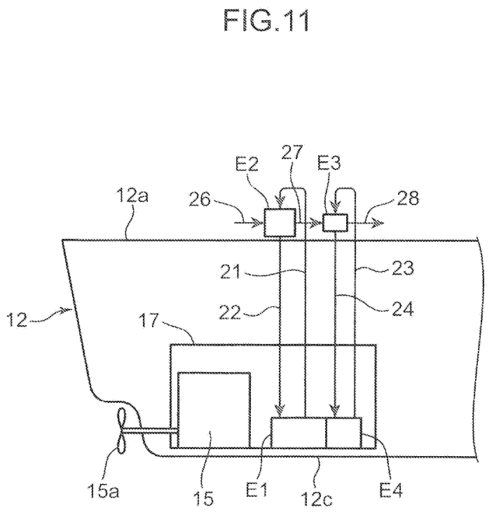

As shown FIG. 11, the intermediate fluid evaporator E1 and the second evaporator E4 may be disposed in an engine room 17 which houses the engine 15. The engine room 17 is disposed on the hull bottom 12c or in the vicinity of the hull bottom 12c. Accordingly, when the intermediate fluid evaporator E1 and the second evaporator E4 are disposed in the engine room 17, the intermediate fluid evaporator E1 and the second evaporator E4 are positioned not only below the load line 13 but also below a sea level at a light load time (a draft when a ship floats on water in a light loaded state where none of humans, cargo, fuel, water and the like are loaded). That is, a screw 15a mounted on an output shaft of the engine 15 is constantly under the sea, and the intermediate fluid evaporator E1 and the second evaporator E4 disposed in the engine room 17 are positioned at substantially the same height as the screw 15a. Accordingly, by arranging the intermediate fluid evaporator E1 and the second evaporator E4 in the engine room 17, the intermediate fluid evaporator E1 and the second evaporator E4 are positioned below the sea level at a light load time and hence, power of the pump 34 can be reduced.

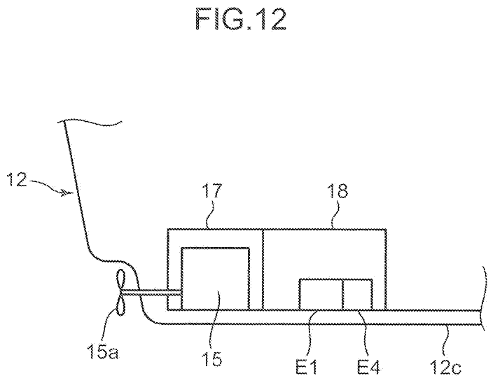

As shown in FIG. 12, the intermediate fluid evaporator E1 and the second evaporator E4 may be disposed in a machine chamber 18 which is disposed in the space S in the hull 12 separately from the engine room 17. The machine chamber 18 is a chamber where machineries for generating power, steam or the like used in the hull 12 are housed, and may be disposed separately from the engine room 17. The machine chamber 18 may be disposed adjacently to the engine room 17 or may be disposed at the position away from the engine room 17. In both cases, the machine chamber 18 may be positioned not only below the load line 13 but also below a sea level at a light load time. Accordingly, by arranging the intermediate fluid evaporator E1 and the second evaporator E4 in the machine chamber 18, a power of the pump 34 can be reduced.

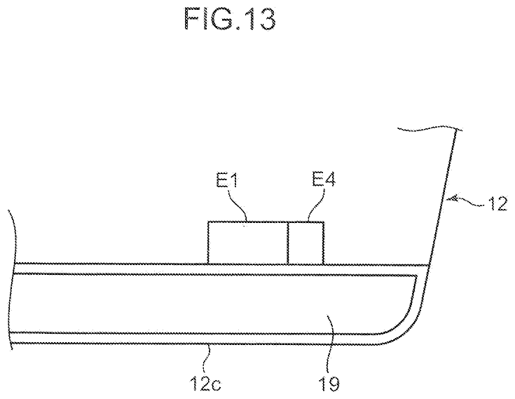

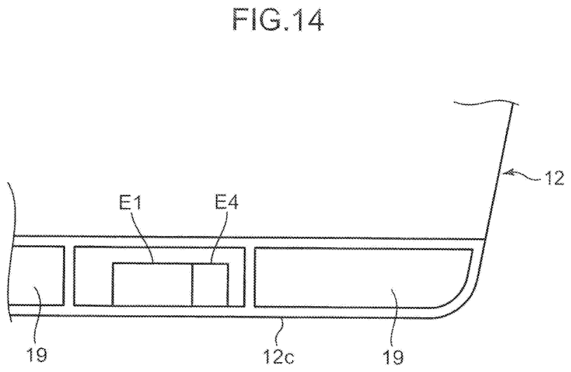

FIG. 13 and FIG. 14 respectively show an example where a ballast tank 19 is formed in the hull 12. In this case, the intermediate fluid evaporator E1 and the second evaporator E4 may be disposed on the ballast tank 19. In the case where a plurality of ballast tanks 19 are provided, some ballast tanks 19 may be used as rooms in which the intermediate fluid evaporator E1 and the second evaporator E4 are disposed without being used as the ballast tank. In this case, the intermediate fluid evaporator E1 and the second evaporator E4 are disposed on the hull bottom 12c or in the vicinity of the hull bottom 12c and hence, a power of the pump 34 can be reduced.

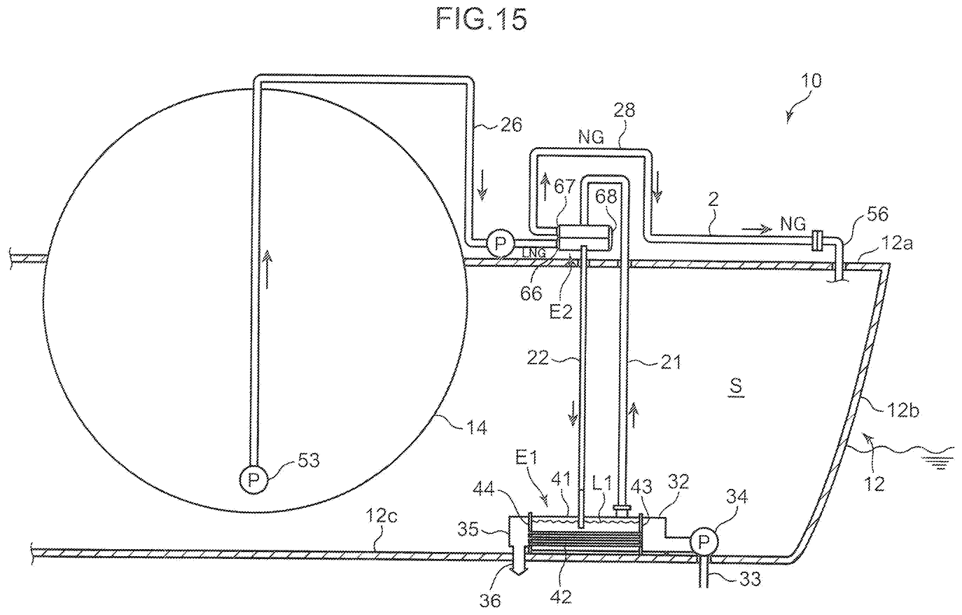

As shown in FIG. 15, the offshore floating facility 10 may be configured such that the heater E3, the second evaporator E4, the second gas pipe 23, the second liquid pipe 24, and the connection pipe 27 of the vaporizer 16 are omitted. In such a configuration, the intermediate chamber 31 is omitted, and the lead-in chamber 32 is formed on a side of the intermediate fluid evaporator E1 opposite to the lead-out chamber 35. The tube sheet 43 which forms one side wall in a longitudinal direction of the shell 41 functions also as a partition wall between the lead-in chamber 32 and the intermediate fluid evaporator E1. The other tube sheet 44 functions also as a partition wall between the intermediate fluid evaporator E1 and the lead-out chamber 35. The first gas pipe 21, the first liquid pipe 22, the introduction pipe 26, and the discharge pipe 28 are connected to the LNG evaporator E2. Further, the first flow passages 61 of the stacked body which forms the LNG evaporator E2 are communicated with the introduction pipe 26 and the discharge pipe 28. The second flow passages 62 are communicated with the first gas pipe 21 and the first liquid pipe 22.

Also in the configuration shown in FIG. 15, the LNG evaporator E2 may be formed of a shell-and-tube-type heat exchanger, or may be formed of a plate-fin-type heat exchanger.

In the case where the offshore floating facility 10 includes the configuration where the heater E, the second evaporator E4, the second gas pipe 23, the second liquid pipe 24, and the connection pipe 27 of the vaporizer 16 are omitted, the intermediate fluid evaporator E1 may be disposed as shown in FIG. 9 to FIG. 14. The connection relationship between the intermediate fluid evaporator E1 and the first liquid pipe 22 may be any one of the relationships shown in FIG. 3 to FIG. 5.

The above-mentioned embodiment is summarized hereinafter.

(1) The offshore floating facility according to the above-mentioned embodiment includes: the hull having a deck; and a intermediate fluid type vaporizer disposed on the hull, wherein the intermediate fluid type vaporizer includes: a pump for pumping sea water; an intermediate fluid evaporating part for evaporating an intermediate fluid by the sea water pumped up by the pump; a liquefied gas vaporizing part for vaporizing a liquefied gas by the intermediate fluid in a gaseous form evaporated in the intermediate fluid evaporating part; a gas pipe for guiding the intermediate fluid in a gaseous form evaporated in the intermediate fluid evaporating part to the liquefied gas vaporizing part; and the liquid pipe for guiding the intermediate fluid condensed in the liquefied gas vaporizing part to the intermediate fluid evaporating part. The liquefied gas vaporizing part is disposed on the deck of the hull, the intermediate fluid evaporating part is disposed below the deck, and the intermediate fluid is allowed to naturally circulate between the intermediate fluid evaporating part and the liquefied gas vaporizing part.

In the offshore floating facility, the deck is positioned at an extremely high place from a sea level. However, the intermediate fluid evaporating part which uses sea water as a heat source is disposed below the deck and hence, power of the pump required for feeding sea water to the intermediate fluid evaporating part can be reduced compared to a case where the intermediate fluid evaporating part is disposed above the deck. On the other hand, the liquefied gas vaporizing part disposed above the deck and the intermediate fluid evaporating part positioned below the deck are connected to each other by the gas pipe and the liquid pipe and hence, the pipe may be elongated. However, in the offshore floating facility, a running cost for generating power of the pump can be reduced and hence, a cost incurred by the elongation of the pipe can be offset. Further, the liquefied gas vaporizing part is disposed on the deck and hence, it is unnecessary to extend the pipe through which a low-temperature liquefied gas flows from above of the deck to the hull bottom.

The distance between the liquefied gas vaporizing part and the intermediate fluid evaporating part can be increased and hence, it is possible to ensure a head of a condensed intermediate fluid whereby a driving force for circulating the intermediate fluid can be easily acquired. As a result, it is possible to avoid the occurrence of a situation where the intermediate fluid in a liquid form is stored in the whole liquid pipe. Accordingly, the natural circulation of the intermediate fluid can be easily generated.

(2) The intermediate fluid evaporating part may be positioned below the load line of the hull.

In this mode, the intermediate fluid evaporating part is disposed below the load line positioned below the deck and hence, the power of the pump required for feeding sea water to the intermediate fluid evaporating part can be further reduced. The distance between the liquefied gas vaporizing part and the intermediate fluid evaporating part can be further increased and hence, a head of the condensed intermediate fluid can be ensured more easily whereby a driving force for circulating the intermediate fluid can be easily acquired.

(3) The intermediate fluid evaporating part may be positioned below a sea level in a state where the hull is at a light load time.

In this mode, the intermediate fluid evaporating part is disposed below the sea level at the light loaded time which is positioned below the load line and hence, the power of the pump required for feeding sea water to the intermediate fluid evaporating part can be further reduced. Further, the distance between the liquefied gas vaporizing part and the intermediate fluid evaporating part can be further increased and hence, a head of the condensed intermediate fluid can be ensured more easily whereby a driving force for circulating the intermediate fluid can be easily acquired.

(4) The intermediate fluid evaporating part may be disposed on the hull bottom of the hull. The hull bottom is positioned below the sea level. Accordingly, the power of the pump required for feeding sea water to the intermediate fluid evaporating part can be further reduced. Further, the distance between the liquefied gas vaporizing part and the intermediate fluid evaporating part can be further increased and hence, a head of the condensed intermediate fluid can be ensured whereby a driving force for circulating the intermediate fluid can be more easily acquired.

The intermediate fluid evaporating part is disposed on the hull bottom and hence, even when the hull rolls, the rolling width of the intermediate fluid evaporating part per se can be suppressed. Accordingly, compared to the case where the intermediate fluid evaporating part is disposed above the deck, a change in liquid surface of the intermediate fluid in a liquid form stored in the intermediate fluid evaporating part can be suppressed. Further, the intermediate fluid evaporating part is disposed on the hull bottom and hence, the intermediate fluid evaporating part can contribute to the stabilization of the hull.

(5) The outflow port of the liquid pipe for the intermediate fluid may be disposed in the intermediate fluid in a liquid form stored in the intermediate fluid evaporating part.

In this mode, the liquid pipe can be liquid-sealed such that the intermediate fluid in a gaseous form does not flow into the liquid pipe from the outflow port for the intermediate fluid in a liquid form. Further, even when the hull rolls so that there is a change in height of a liquid surface of the intermediate fluid, so long as the rolling is small, a state where the liquid pipe is liquid-sealed can be maintained.

(6) The intermediate fluid evaporating part may have a group of heat transfer tubes through which sea water flows. In this case, the outflow port of the liquid pipe for the intermediate fluid may be disposed at a position below an uppermost portion of the group of the heat transfer tubes.

In this mode, the liquid pipe can be liquid-sealed such that the intermediate fluid in a gaseous form does not flow into the liquid pipe from the outflow port for the intermediate fluid in a liquid form. Further, even when the hull rolls, so long as a height of the liquid surface of the intermediate fluid changes to the extent that the heat transfer tubes disposed at an uppermost position out of the group of heat transfer tubes formed of the large number of heat transfer tubes are exposed, a state where the liquid pipe is liquid-sealed can be maintained. Accordingly, even when the heat transfer tubes disposed at an uppermost position out of the group of heat transfer tubes are exposed from the liquid surface, it is possible to prevent the low-temperature intermediate fluid which flows downward through the liquid pipe from directly impinging on the heat transfer tubes without coming into contact with the intermediate fluid in a liquid form stored in the intermediate fluid evaporating part.

(7) The intermediate fluid evaporating part may have a group of heat transfer tubes through which sea water flows. In this case, the outflow port of the liquid pipe for the intermediate fluid may be disposed at a position below the group of heat transfer tubes.

In this mode, the liquid pipe can be liquid-sealed such that the intermediate fluid in a gaseous form does not flow into the liquid pipe from the outflow port for the intermediate fluid in a liquid form. Even when the hull rolls to the extent that most of the heat transfer tubes out of the group of heat transfer tubes are exposed, a state where the liquid pipe is liquid-sealed can be maintained. Accordingly, even when most of the heat transfer tubes out of the group of heat transfer tubes are exposed from a liquid surface, it is possible to prevent the low-temperature intermediate fluid which flows downward through the liquid pipe from directly impinging on the heat transfer tubes without coming into contact with the intermediate fluid in a liquid form stored in the intermediate fluid evaporating part.

(8) The intermediate fluid type vaporizer may include: a second intermediate fluid evaporating part for evaporating a second intermediate fluid by sea water pumped by the pump; a gas heater for heating a gas vaporized by the liquefied gas vaporizing part by the second intermediate fluid in a gaseous form evaporated in the second intermediate fluid evaporating part; a second gas pipe for guiding the second intermediate fluid in a gaseous form evaporated in the second intermediate fluid evaporating part to the gas heater; and a second liquid pipe for guiding the second intermediate fluid condensed in the gas heater to the second intermediate fluid evaporating part. In this case, the gas heater may be disposed on the deck. The second intermediate fluid evaporating part may be disposed below the deck. The second intermediate fluid may be allowed to naturally circulate between the second intermediate fluid evaporating part and the gas heater.

In this mode, the second intermediate fluid evaporating part which uses sea water as a heat source is disposed below the deck and hence, power of the pump required for feeding sea water to the second intermediate fluid evaporating part can be reduced compared to the case where the second intermediate fluid evaporating part is disposed above the deck. On the other hand, the gas heater and the second intermediate fluid evaporating part are connected to each other by the second gas pipe and the second liquid pipe and hence, the pipes may be elongated. However, in the offshore floating facility, a running cost for generating power of the pump can be reduced and hence, a cost incurred by the elongation of the pipe can be offset. Further, both the liquefied gas vaporizing part and the gas heater are disposed above the deck and hence, it is sufficient that pipes provided for feeding a liquefied gas or a gas to the liquefied gas vaporizing part and the gas heater are routed around on the deck. Accordingly, it is possible to prevent the piping configuration from becoming complicated.

The distance between the gas heater and the second intermediate fluid evaporating part can be increased and hence, a head of the condensed intermediate fluid can be easily ensured so that a sufficient driving force for circulating the intermediate fluid can be easily acquired. As a result, it is possible to avoid the occurrence of a situation where the intermediate fluid in a liquid form is stored in the whole liquid pipe. Further, it is possible to easily ensure a head of the condensed second intermediate fluid. Accordingly, the natural circulation of the second intermediate fluid can be easily generated.

(9) The second intermediate fluid evaporating part may be positioned below the load line of the hull.

In this mode, the second intermediate fluid evaporating part is disposed below the load line positioned below the deck and hence, power of the pump required for feeding sea water to the second intermediate fluid evaporating part can be further reduced. The distance between the gas heater and the second intermediate fluid evaporating part can be further increased and hence, a head of the condensed second intermediate fluid can be ensured more easily whereby a driving force for circulating the second intermediate fluid can be more easily acquired.

(10) The second intermediate fluid evaporating part may be positioned below a sea level in a state where the hull is at a light load time.

In this mode, the second intermediate fluid evaporating part is disposed below the sea level at the light loaded time which is positioned below the load line and hence, power of the pump required for feeding sea water to the second intermediate fluid evaporating part can be further reduced. Further, the distance between the gas heater and the second intermediate fluid evaporating part can be further increased and hence, a head of the condensed second intermediate fluid can be ensured more easily whereby a driving force for circulating the second intermediate fluid can be easily acquired.

(11) The second intermediate fluid evaporating part may be disposed on the hull bottom of the hull. The hull bottom is positioned below the sea level. Accordingly, power of the pump required for feeding sea water to the second intermediate fluid evaporating part can be further reduced. The distance between the gas heater and the second intermediate fluid evaporating part can be further increased and hence, a head of the condensed second intermediate fluid can be ensured more easily whereby a driving force for circulating the second intermediate fluid can be easily acquired.

The second intermediate fluid evaporating part is disposed on the hull bottom and hence, even when the hull rolls, the rolling width of the second intermediate fluid evaporating part per se can be suppressed. Accordingly, compared to the case where the second intermediate fluid evaporating part is disposed on the deck, a change in liquid surface of the second intermediate fluid in a liquid form stored in the second intermediate fluid evaporating part can be suppressed. Further, the second intermediate fluid evaporating part is disposed on the hull bottom and hence, the second intermediate fluid evaporating part can contribute to the stabilization of the hull.

(12) The outflow port of the second liquid pipe for the second intermediate fluid may be positioned in the second intermediate fluid in a liquid form stored in the second intermediate fluid evaporating part.

In this mode, the second liquid pipe can be liquid-sealed such that the second intermediate fluid in a gaseous form does not flow into the second liquid pipe from the outflow port for the second intermediate fluid in a liquid form. Further, even when the hull rolls so that there is a change in height of a liquid surface of the second intermediate fluid, so long as the rolling is small, a state where the second liquid pipe is liquid sealed can be maintained.

(13) The second intermediate fluid evaporating part may have the group of heat transfer tubes through which sea water flows. In this case, the outflow port of the second liquid pipe for the second intermediate fluid may be positioned below the uppermost portion of the group of heat transfer tubes.

In this mode, the second liquid pipe can be liquid-sealed such that the second intermediate fluid in a gaseous form does not flow into the second liquid pipe from the outflow port for the second intermediate fluid in a liquid form. Further, even when the hull rolls, so long as a height of the liquid surface of the second intermediate fluid changes to the extent that the heat transfer tubes disposed at an uppermost position out of the group of heat transfer tubes formed of the large number of heat transfer tubes are exposed, a state where the second liquid pipe is liquid-sealed can be maintained. Accordingly, even when the heat transfer tubes disposed at an uppermost position out of the group of heat transfer tubes are exposed from the liquid surface, it is possible to prevent the low-temperature second intermediate fluid which flows downward through the second liquid pipe from directly impinging on the heat transfer tubes without coming into contact with the second intermediate fluid in a liquid form stored in the second intermediate fluid evaporating part.

(14) The second intermediate fluid evaporating part may have the group of heat transfer tubes through which the sea water flows. In this case, the outflow port of the second liquid pipe for the second intermediate fluid may be positioned below the group of heat transfer tubes.

In this mode, the second liquid pipe can be liquid-sealed such that the second intermediate fluid in a gaseous form does not flow into the second liquid pipe from the outflow port for the second intermediate fluid in a liquid form. Even when the hull rolls to the extent that most of the heat transfer tubes out of the group of heat transfer tubes are exposed, a state where the second liquid pipe is liquid-sealed can be maintained. Accordingly, even when most of the heat transfer tubes out of the group of heat transfer tubes are exposed from the liquid surface, it is possible to prevent the low-temperature second intermediate fluid which flows downward through the second liquid pipe from directly impinging on the heat transfer tubes without coming into contact with the second intermediate fluid in a liquid form stored in the second intermediate fluid evaporating part.

As described heretofore, in the offshore floating facility where the intermediate fluid type vaporizer is used, it is possible to reduce a running cost.

1. An offshore floating facility comprising:
a hull having a deck; and
an intermediate fluid type vaporizer disposed on the hull, wherein
the intermediate fluid type vaporizer includes:
a pump for pumping sea water;
an intermediate fluid evaporating part for evaporating an intermediate fluid by the sea water pumped by the pump;
a liquefied gas vaporizing part for vaporizing a liquefied gas by the intermediate fluid in a gaseous form evaporated in the intermediate fluid evaporating part;
a gas pipe for guiding the intermediate fluid in a gaseous form evaporated in the intermediate fluid evaporating part to the liquefied gas vaporizing part; and
a liquid pipe for guiding the intermediate fluid condensed in the liquefied gas vaporizing part to the intermediate fluid evaporating part,
the liquefied gas vaporizing part is disposed on the deck of the hull, the intermediate fluid evaporating part is disposed below the deck, and the intermediate fluid is allowed to naturally circulate between the intermediate fluid evaporating part and the liquefied gas vaporizing part.

2. The offshore floating facility according to claim 1, wherein the intermediate fluid evaporating part is positioned below a load line of the hull.

3. The offshore floating facility according to claim 1, wherein the intermediate fluid evaporating part is positioned below a sea level in a state where the hull is at a light load time.

4. The offshore floating facility according to claim 1, wherein the intermediate fluid evaporating part is disposed on a hull bottom of the hull.

5. The offshore floating facility according to claim 1, wherein an outflow port of the liquid pipe for the intermediate fluid is positioned in the intermediate fluid in a liquid form stored in the intermediate fluid evaporating part.

6. The offshore floating facility according to claim 1, wherein
the intermediate fluid evaporating part has a group of heat transfer tubes for flowing the sea water, and
an outflow port of the liquid pipe for the intermediate fluid is positioned below an uppermost portion of the group of heat transfer tubes.

7. The offshore floating facility according to claim 1, wherein
the intermediate fluid evaporating part has a group of heat transfer tubes for flowing the sea water, and
an outflow port of the liquid pipe for the intermediate fluid is positioned below the group of heat transfer tubes.

8. The offshore floating facility according to claim 1, wherein
the intermediate fluid type vaporizer includes:
a second intermediate fluid evaporating part for evaporating a second intermediate fluid by the sea water pumped by the pump;
a gas heater for heating a gas vaporized by the liquefied gas vaporizing part by the second intermediate fluid in a gaseous form evaporated in the second intermediate fluid evaporating part;
a second gas pipe for guiding the second intermediate fluid in a gaseous form evaporated in the second intermediate fluid evaporating part to the gas heater; and
a second liquid pipe for guiding the second intermediate fluid condensed in the gas heater to the second intermediate fluid evaporating part, and
the gas heater is disposed on the deck, the second intermediate fluid evaporating part is disposed below the deck, and the second intermediate fluid is allowed to naturally circulate between the second intermediate fluid evaporating part and the gas heater.

9. The offshore floating facility according to claim 8, wherein the second intermediate fluid evaporating part is positioned below the load line of the hull.

10. The offshore floating facility according to claim 8, wherein the second intermediate fluid evaporating part is positioned below a sea level in the state where the hull is at a light load time.

11. The offshore floating facility according to claim 8, wherein the second intermediate fluid evaporating part is disposed on a hull bottom of the hull.

12. The offshore floating facility according to claim 8, wherein an outflow port of the second liquid pipe for the second intermediate fluid is positioned in the second intermediate fluid in a liquid form stored in the second intermediate fluid evaporating part.

13. The offshore floating facility according to claim 8, wherein
the second intermediate fluid evaporating part has a group of heat transfer tubes for flowing the sea water, and
an outflow port of the second liquid pipe for the second intermediate fluid is positioned below an uppermost portion of the group of heat transfer tubes.

14. The offshore floating facility according to claim 8, wherein
the second intermediate fluid evaporating part has a group of heat transfer tubes for flowing the sea water, and
an outflow port of the second liquid pipe for the second intermediate fluid is positioned below the group of heat transfer tubes.
